(19) United States
(12) Patent Application Publication
(10) Pub. No.: US 2026/0260988 A1
(43) Pub. Date: Sep. 3, 2026

(54) INTUMESCENT SHEET USED IN AN ELECTRIC VEHICLE BATTERY FOR THERMAL RUNAWAY MANAGEMENT

(71) Applicant: Aerogel R&D PTE LTD., Chinatown Point (SG)

(72) Inventors: Jong Chul PARK J, Daejeon (KR); Mohamed Anees SHEIK, Jurong West (SG); Bao Yi NG, Jurong West (KR); Hui Yi, NEO, Symphony Heights (SG)

(21) Appl. No.: 18/873,314

(22) PCT Filed: Jun. 9, 2023
(86) PCT No.: PCT/SG2023/050409

§ 371 Date: Dec. 9, 2024

(30) Foreign Application Priority Data
Jun. 10, 2022 (SG) 10202250123S
Dec. 16, 2022 (SG) 10202260465W

(51) Int. Cl. H01M 50/24; A62C 2/06; A62C 3/16; B60L 50/64; C04B 14/06; C04B 14/30; C04B 14/42; C04B 22/06; C04B 24/02; C04B 24/42; C04B 28/26; C04B 103/40; C04B 103/63; C04B 111/00; C04B 111/28; H01M 10/625; H01M 10/647; H01M 10/658; H01M 50/209; H01M 50/249; H01M 50/293

(52) U.S. Cl. CPC H01M 50/24; A62C 2/065; A62C 3/16; B60L 50/64; C04B 14/06; C04B 14/303; C04B 14/42; C04B 22/066; C04B 24/02; C04B 24/42; C04B 28/26; H01M 10/625; H01M 10/647; H01M 10/658; H01M 50/209; H01M 50/249; H01M 50/293; C04B 2103/40; C04B 2103/63; C04B 2111/00853; C04B 2111/285; H01M 2220/20

(57) ABSTRACT

An intumescent sheet to be used in an Electric Vehicle Battery for thermal runaway management, wherein out of 100 weight percentage (wt %) of the intumescent sheet, the intumescent sheet comprises: 5 to 20 wt % of non-woven fiber mat; 60 to 95 wt % of an alkali-silicate based binder; and 0.5 to 10 wt % of microporous and/or mesoporous and/or nanoporous additive, wherein the non-woven fiber mat is infused with the alkali-silicate based binder by impregnation of the non-woven fiber mat with an alkali-silicate based solution.

### CROSS-REFERENCE TO RELATED APPLICATION

This application is a national phase application of International Application No. PCT/SG2023/050409, filed Jun. 9, 2023, which is incorporated herein by reference in its entirety.

### FIELD

The present invention relates to an intumescent sheet to be used in an Electric Vehicle (EV) Battery for Thermal Runaway Management, and a method of manufacturing the intumescent sheet. In particular, passive thermal runaway management and fire protection of EV batteries may be provided. One or more of the intumescent sheet may be used in various levels of the EV batteries such as in spacing between cells, and as a lining for inner-walls of modules or battery packs.

### BACKGROUND

The global Electric Vehicle (EV) market has seen immense growth over the past decade reaching 163.01 billion USD in year 2020 with projections of reaching 823.75 billion USD by 2030. Factors such as increasing number of countries being involved in the fight against climate change and commitments toward net-zero carbon emissions as well as rising fuel prices have been the thrust behind the growth. However, despite its popularity, fire safety concerns regarding the Lithium-Ion Batteries (LiB) used in EVs have been a significant hurdle to reaching much wider adoption. Numerous fire incidents related to EV batteries have been reported with Hyundai and General Motors having to recall more than 100,000 vehicles each in 2020 due to such incidents. This clearly demonstrates the importance of improved fire protection to alleviate these concerns.

With reference to FIG. 1, the EV LiB is made up of 3 levels namely: cells (104), modules (102) and battery pack (100). An array of cells (104) makes up a module (102) and a group of modules (102) make up the battery pack (100). The maximum operating temperature range for the LiB is typically 150° C. or lower. If a cell's temperature exceeds this operating temperature limit, it could trigger uncontrollable accelerated exothermic chain of reactions causing temperatures to rise up to 900° C. with release of large amounts of fumes, shrapnel and other particulates in an explosive manner in a process termed “thermal runaway”. The high temperature and pressure generated from the thermal runaway from one cell could trigger the thermal runaway of the next if not contained. Subsequently, a thermal runaway ‘domino effect’ whereby all the cells in the module and eventually the entire battery pack undergoes thermal runaway may occur in a very short amount of time, thereby posing a huge explosive fire hazard to the EV.

Generally, two types of thermal runaway management systems are employed for prevention of multiple cells from undergoing thermal runaway. The first ensures that the temperature of each cell does not exceed the maximum operating temperature. The second ensures that in the event that one of the cells does undergo thermal runaway, adjacent cells are prevented from undergoing thermal runaway.

The first type of thermal runaway management system comprises active monitoring systems, whereby sensors are employed to detect if temperatures or voltages are reaching unsafe levels in real-time such as that described in U.S. Pat. No. 7,433,794B1. However, such systems may not be economically viable.

The first type of thermal runaway management system also comprises passive systems such as fluid cooling via heat exchanging principle whereby a module is immersed in circulating cooling-liquid (i.e. refrigerant) or air such as that described in US Patent Application no. 20200112073A1 or Japan Patent no. JP6331017B2 respectively.

Furthermore, heat spreaders, which are highly thermally conductive and radiative sheets, can be used as spacers between cells to evenly spread out the heat between the cells in a module and release heat into surrounding via radiation, thereby reducing the risk of any of the cells undergoing thermal runaway. As an example, Korean patent no. KR200479471Y1 employs a compressed sheet made of exfoliated graphite particles or a graphitized polyimide sheet with in-plane thermal conductivity of 300 W/mK. However, in the event that thermal runaway does occur to one cell, such heat spreaders may increase the possibility of all cells undergoing thermal runaway due to high thermal conductivity. Furthermore, such heat spreaders may not have the dielectric strength to prevent surges in voltage from one cell from being transferred to the adjacent cells, which triggers thermal runaway.

Finally, sheets made of phase-change materials may also be employed between cells to reduce heat arising from any of the cells, reducing the risk of any cell undergoing thermal runaway. Examples of this are described in Chinese patent document CN105742755B whereby paraffin-expanded graphite composite are used as phase-change layer. The downside of using such phase-change sheets is that there is a limit to the amount of heat such sheets are able to absorb i.e. once all molecules have undergone phase-change, the sheet is unable to absorb more heat. Furthermore, such phase change sheets, especially if flammable phase-change material such as paraffins are used, could accelerate the thermal runaway of adjacent cells if one of the cells undergoes thermal runaway. Combinations of phase-change sheets and heat spreaders as composite laminates have also been employed as seen in Chinese patent document CN107887671B and the disadvantages of phase-change sheets are present.

The second type of thermal runaway management comprises the use of heat resistant insulation foams, sheets or intumescent sheets or a combination thereof as spacers between cells as means to prevent adjacent cells from undergoing thermal runaway when one cell is undergoing thermal runaway. Foams are a common choice as a spacer for this technique due to its low thermal conductivity. However, a drawback of foams is that its working principle is in opposition with the principle of heat spreading during normal battery operation i.e. during normal battery operation, if a cell is heating up, foam prevents the heat from spreading and thereby increasing the risk of that cell undergoing thermal runaway.

An example of a foam spacer would be that described in International patent publication no. WO2021019495A1, which employs a flexible flame-retardant polymeric foam that is used in conjunction with a water-based fire resistant silicone elastomer and inorganic fiber layer. During thermal runaway, it is not possible for the integrity of such polymeric foam to be maintained and hence, there is a need for the polymeric intumescent coating in this patent document. However, the resultant expanded fluffy carbonaceous char resulting from the expansion of the intumescent coating would have poor dielectric resistance as well as poor ability to withstand the high pressure of fumes and shrapnel.

Another example of a foam is the flexible silica aerogel sheet used in Chinese patent document CN108862286B. Despite the fire and heat resistance it offers, the ability for it to prevent transfer of highly pressured fumes and shrapnel is doubtful due to the porosity and lack of mechanical strength.

Canadian Patent no. CA3008606C describes a composite laminate whereby heat conductive polymeric sheets with low melting point are laminated with intumescent layers. During normal operation, heat-spreading reduces risk of thermal runaway of each cell and upon thermal runaway of one cell, the heat-conductive polymer layers in the adjacent spacer melt easily allowing the intumescent layers to expand and form a low-thermal conductive carbonaceous char across the participating cell and adjacent cells. However, the dielectric strength of the resultant carbonaceous char as well as the mechanical strength to resist pressure from the fumes and shrapnel are of significant concern.

In JP2013528911A, an endothermic fire-resistant coating such as gypsum is used to coat onto part or an entire exterior of the cell array in a module as well as individual cells. It is expected that the char generated during thermal runaway event will have higher dielectric strength and mechanical strength than carbonaceous char but the mechanical strength may still not be enough to withstand the pressure generated from fumes and shrapnel. Furthermore, the thermal conductivity of the generated char is expected to be significantly higher than carbonaceous char.

### SUMMARY

According to an example of the present disclosure, there is provided an intumescent sheet as claimed in the independent claim. Some optional features are defined in the dependent claims.

### BRIEF DESCRIPTION OF DRAWINGS

FIG. 1 (Prior Art) is a schematic representation of the typical 3 levels in an Electric Vehicle battery.

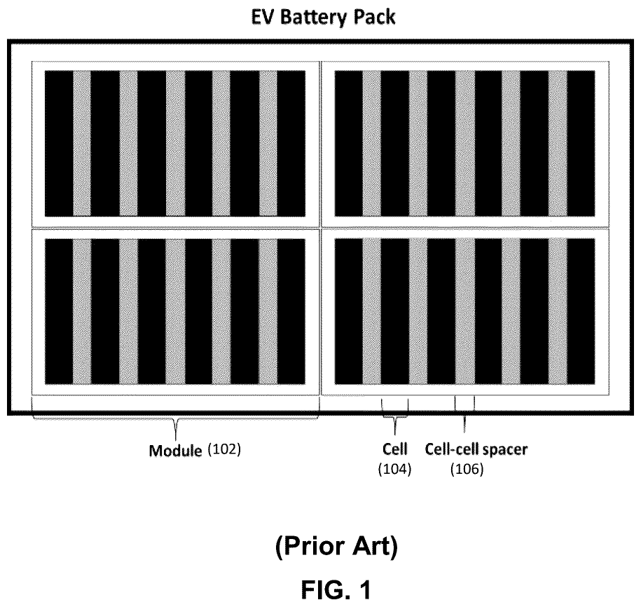

### DETAILED DESCRIPTION

Examples of the present disclosure comprise an intumescent sheet with thickness below 2 mm that is capable of expanding to produce a mechanically robust inorganic char with good thermal insulation and dielectric strength. “char” refers to a material that has been charred or burnt. The intumescent sheet may be made of inorganic material or not. The intumescent sheet may be thin like 1 mm or below, or thicker than 1 mm depending on application. One or more of the intumescent sheets can be used as spacers in an Electric Vehicle (EV) battery. These spacers can reside between cells as well as inner-wall linings of a module and in battery pack casings. This prevents multiple cells from undergoing thermal runaway as well as contain fire within the module/battery pack in the event that thermal runaway occurs. A plurality of the intumescent sheets may be stacked layer by layer to form a laminate or laminates with a thickness as required by application. The laminate or laminates may be laminated or coated in walls of the cells, module and/or casing of the EV battery.

In the present disclosure, an Electric Vehicle (EV) refers to a vehicle that uses one or more electric motors for propulsion and is typically powered by a battery. EVs include but are not limited to, road and rail vehicles (e.g. electric scooters, electric bicycles, electric cars, space exploration vehicles, etc.), surface and underwater vessels, electric aircraft (e.g. manned/unmanned planes and air-drones etc.), and electric spacecraft.

Due to space constraint being a critical factor for EV battery manufacturers, thin spacers with thicknesses as low as 2 mm or below are highly desirable. Various approaches to manage the thermal runaway in EV Lithium Battery (LiB) have been adopted but there is still lack of a thin cell-cell spacer, module linings, and battery pack linings that could provide relatively good thermal conductivity during normal operating conditions and a very low thermal conductivity with excellent mechanical strength and dielectric resistance when the thermal runaway of one or more cells occurs. Examples of the present disclosure provide an intumescent sheet or sheets that address these issues. In particular, an intumescent sheet with a thickness of less than or equal to 1 mm is proposed in the present disclosure.

Compared to the use of foams, intumescent coatings or sheets have an advantage of higher thermal conductivity before the thermal runaway of the cell (i.e. during normal operating condition). They allow heat-spreading, and upon thermal runaway of a first cell, they undergo expansion to form a low thermal conductivity char to prevent thermal runaway of the adjacent cells.

In an example of the present disclosure, there is provided an inorganic intumescent sheet and in its most basic form, it comprises of a non-woven inorganic fiber mat that is impregnated with a water-based and alkali-silicate based solution. In this example, the impregnating solution comprises an alkali-silicate based binder, thermal insulation imparting additive that is porous, char strength-imparting additives, one or more surfactants, water, one or more hardening agent, and other additives like an organic additive. The intumescent sheet has an alkali-silicate based coating containing these additives after it is dried and/or cured.

The alkali-silicate based binder can refer to lithium silicate, potassium silicate and sodium silicate or a mixture thereof. Potassium silicate and/or sodium silicate is preferred as lithium silicate is significantly costlier. Such alkali-silicates are capable of expanding to produce inorganic intumescent chars at high temperatures. Sodium silicate is less stable than potassium silicate, requires a lower temperature for expansion, and hence can be activated earlier in the event of thermal runaway in one cell. Hence, between potassium silicate and sodium silicate, sodium silicate is the preferred choice if earlier activation is required.

The “silicon dioxide:alkali oxide” molar ratio of the alkali-silicate binder determines the properties such as curing rate, flexibility of the cured sheet as well as extent of expansion and mechanical robustness of char when the cured sheet is exposed to high temperature. The “cured sheet” refers to the inorganic intumescent sheet of the abovementioned example after it is made. A low ratio would result in high expansion, low mechanical robustness of char, high flexibility of the cured sheet and slow cure rate whereas vice-versa holds true for higher ratio. Considering the best compromise between the factors, it is preferable for the molar ratio to be in the range of 2.5 to 4, and more preferably in the range of 3 to 3.3. The alkali-silicate content should be between 60-95 weight percentage (wt %) of the intumescent sheet, and more preferably between 75-85 wt % of the intumescent sheet for a good balance between intumescent capability and mechanical robustness of char.

Microporous and/or mesoporous and/or nanoporous additive is added in the intumescent sheet of the abovementioned example, as an agent that enables the formation of char with a dense network and with a high pore volume fraction being representative of evenly distributed microporous and/or mesoporous and/or nanoporous network. The microporous and/or mesoporous and/or nanoporous additive is a thermal insulation imparting additive. It can be added in the range of 0.5 to 10 wt % of the intumescent sheet depending on the miscibility of the insulation imparting additive in the impregnation solution (i.e. water-based and alkali-silicate based solution). The microporous and/or mesoporous and/or nanoporous additive can impart densification to the intumescent sheet. Furthermore, the microporous and/or mesoporous and/or nanoporous additive can be silica and/or silicate in nature.

Examples of the microporous and/or mesoporous and/or nanoporous additive include, but not limited to, hollow microglass spheres, fumed silica, cenospheres, and aerogel particles. It has been observed that adding aerogel particles with hydrophobic surface groups has demonstrated good performance to forming chars with dense network and large volume fraction of pores being microporous and/or mesoporous. More preferably, aerogel particles with particle size of 10-60 μm, pore diameter of 5-50 nm, porosity >90%, bulk density of 0.02-0.1 g/cm³ and surface area of 500-900 m²/g can be chosen. The aerogel content should be between 0.5-10 wt % of the intumescent sheet and preferably between 1-5 wt % of the intumescent sheet. Above the recommended range, dispersion becomes an issue whereas below the range, the insulation improvement to the char is not significant enough.

Without the addition of the microporous and/or mesoporous and/or nanoporous additive, the intumescent char arising from the intumescent sheet having the alkali-silicate based binder alone may be a loosely connected network with a large pore size distribution.

For purposes of comparison, a sample of the char of (a) the alkali-silicate based binder alone was magnified 100 times and 1000 times, and a sample of the char of (b) the intumescent sheet having the alkaline-silicate based binder with addition of 1 wt % of the aforementioned aerogel particles was magnified 100 times, 1000 times, and 5000 times. The char of (a) shows a loosely connected network with large pore size distribution. The pore sizes are uneven, and the walls forming the pores appear weak and brittle. In contrast, the char of (b) shows a significantly denser network with a significantly high pore volume fraction representative of evenly distributed microporous and/or mesoporous and/or nanoporous network. At 100 times magnification, almost every pore is visible and appear large for the char of (a) but for the char of (b), very few pores have the same large size appearance and most of the pores are not visible. Even at higher magnifications of 5000 times, the pore volume of the char of (b) still appears very high and the pore distribution still appears evenly distributed. At 1000 times magnification, one can only see the walls of very few pores for the char of (a). However, the pores and their walls of the char of (b) are barely visible even at 5000 times magnification. From this comparison, it is clear that the resultant char from the example of the alkali-silicate-aerogel combination has excellent performance in thermal insulation and strength of the char. The char has such a dense network, high pore volume and distribution. It should be noted that such microporous and/or mesoporous and/or nanoporous additive do not cause or affect the extent or effect of intumescence, which mainly arises from the degradation of the alkali-silicate based binder. Having such additive enhances the strength of the char and its ability to reduce its rate of transfer of heat flux.

Optionally, char strength enhancing additive can be included in the intumescent sheet of the abovementioned example to further improve the mechanical robustness, insulation and fire-retardant properties of the char. Char strength enhancing additive includes one or more metal salts, which include, but are not limited to, metal oxide such as magnesium oxide, aluminium oxide, calcium oxide, and zinc oxide, metal hydroxide such as aluminium trihydrate and magnesium dihydroxide, metal carbonate such as calcium carbonate and zinc carbonate and metal silicates such as mica and talc, and metal powder such as iron, zinc and aluminium, individually or any combination thereof. The above-mentioned metal hydroxides and carbonates can further serve as endothermic additives that could offer extra fire protection via endothermic cooling at higher temperatures (i.e greater than 200° C.). The total loading level of such char strength enhancing additive added should be between 1-10 wt % of the intumescent sheet, or preferably between 3-8 wt % of the intumescent sheet for optimum balance between intumescent capability and mechanical robustness of char.

Optionally, 1-10 wt % of an opacifier such as iron oxide, silicon carbide, and titania can be added to the intumescent sheet. The opacifier provides high temperature thermal insulation and serves to reflect and thereby reduce heat transfer via radiation at high temperatures.

Optionally, a surfactant can be added in the impregnation solution (i.e. water-based and alkali-silicate based solution) used in the manufacturing of the intumescent sheet of the abovementioned example. Adding the surfactant improves the dispersion of additives and the ability of the impregnation solution to spread and wet the non-woven fiber mat. Due to the alkaline nature of the impregnation solution, the surfactant should be chosen such that it is stable in a range of pH 2 to 12. Preferably, the surfactant or admixture thereof is chosen from a group comprising of an amine oxide, an alkyl carbohydrate ester, an alkoxylated polysiloxane and a poly alkyl acrylate. The surfactant loading level can be between 0.05 to 2 wt % of the impregnation solution, and preferably between 0.2 to 0.5 wt % of the impregnation solution as higher surfactant loading levels could cause undesirable alteration of the fire-retardant properties, whereas lower loading levels may not improve the homogeneity and ability to wet the non-woven sufficiently.

Optionally, a hardening agent can be added in the impregnation solution (i.e. water-based and alkali-silicate based solution) used during the manufacturing of the intumescent sheet of the abovementioned example. Adding the hardening agent improves the drying and curing time of the impregnated non-woven fiber mat. Such hardening agent facilitates the mass production of the intumescent sheets, especially for conveyor belt type continuous manufacturing lines, and can be broadly categorized as acid-based or alkali-based hardener. Acid-based hardener includes, but is not limited to, hydrochloric acid, sulphuric acid, phosphoric acid, formic acid, aluminium phosphate and sodium fluorosilicate, whereas the most commonly used alkali based hardener is potassium methyl siliconate. Acid in the form of solid powders with a slow dissolving nature is preferred, so as to prevent coagulation during working time (i.e. during impregnation of the non-woven fiber mat) and hence, preferably sodium fluorosilicate is chosen amongst the acid-hardeners. Potassium methyl siliconate is the preferable choice amongst the alkali hardeners. Additionally, the hardening agent improves the water-resistance of the cured impregnated intumescent sheet being made, thereby reducing risk of damage during storage. The loading level of the hardening agent depends specifically on the manufacturing method and demand. However, high loading levels tend to reduce flexibility significantly, and hence it is preferable that lesser than 10 wt % of the intumescent sheet constitutes such hardening agent.

Optionally, organic additive can be added to enhance flexibility and water resistance of the intumescent sheet of the abovementioned example. To this end, numerous organic additives and combinations thereof can be added. For example, they can come in the form of a latex, emulsion, suspension, solution or solid powder. The organic additive can include but is not limited to thermoplastic or thermosetting polymers such as polymethyl methacrylae, polyacrylic acid, polyvinyl alcohol, polyvinyl acetate, polyvinylacrylate, polyvinylpyrrolidine, poly(ethyl-vinyl acetate), styrene-butadiene rubber, polyethylene glycol, polyurethane, polyester and epoxy as well as organic molecules or macromolecules such as ethylene glycol, pentaerythritol, glycerol, starch, mannitol, carboxymethylcellulose. Water-based organic additives are preferred as they can be stably added into the impregnation solution without forming aggregation during working time. Amongst them, glycerol and polyvinyl alcohol in particular have demonstrated good miscibility and improvements in flexibility without compromising fire retardation performance when added at appropriate levels, and hence, they are preferred choices. Addition of high loading levels of such organic additive could result in significant reduction in fire retardant performance, and hence it is preferable that addition of such organic additive should be less than 10 wt % of the intumescent sheet.

The inorganic non-woven fiber mat of the intumescent sheet of the abovementioned example has two important functions. It increases flexibility of the intumescent sheet as well as ensures greater mechanical robustness of char that forms during a thermal runaway incident in an EV battery. Glass fiber based non-woven fiber mat is preferred. It is defined by type, diameter and length of fibres used, type and amount of binder used, and area density (i.e g/m²). A suitable choice of non-woven glass fiber mat or fabric for producing the intumescent sheet includes types E, S, C, R, T, and A. E and S types are the preferred choices. The diameter and length of the fiber can be between 8-18 μm and 10-75 mm respectively, and preferably between 10-15 μm and 15-60 mm. The type of binder chosen should be stable in an alkali environment and any coolants that the intumescent sheet will be exposed to inside the EV battery. The amount of binder should be enough to impart flexibility but not too high that it would negatively affect fire retardation performance. For example, a polymeric binder can be used. Specifically, acrylic resin can be chosen as the binder, with binder content being between 5-20 wt % of the non-woven fiber mat, and preferably between 8-15 wt % of the non-woven fiber mat. The area density can be below 400 g/m², and preferably between 30-280 g/m². The non-woven fiber mat can comprise of 5-20 wt % of the intumescent sheet composition, and preferably 8-16 wt % of the intumescent sheet.

To produce the intumescent sheet of the abovementioned example, the non-woven fiber mat is firstly layered on a non-stick polymeric sheet and impregnated by an aqueous alkali-silicate based solution (also known as “impregnation solution” in the present disclosure) comprising, for example, out of 100 wt % of the alkali-silicate based solution,
a. 70-95 wt % of aqueous sodium silicate;
b. 0.5-10 wt % of the abovementioned microporous and/or mesoporous and/or nanoporous additive;
c. optionally, 1-10 wt % of the abovementioned char strength-imparting ceramic additive;
d. optionally, less than 10 wt % of the abovementioned hardening agent;
e. optionally, less than 10 wt % of the abovementioned organic additive;
f. optionally, 0.05-2 wt % of the abovementioned surfactant; and
g. optionally, 2-10 wt % of water for reducing viscosity.

Various methods of impregnation could be adopted such as spraying, brushing and/or doctor-blading. Preferably, doctor-blading is adopted for better thickness control and viability for high volume production. Drying is then performed at a suitable temperature (e.g. room temperature) to remove the water without causing defects such as warping. The objective is to make the sheet dry enough to be able to be easily peeled off the non-stick polymeric sheet. Optionally, curing can be performed at a higher temperature (e.g. 60° C.) to quicken the process. The drying and/or curing can be performed via application of hot air, microwave heating, infra-red heating etc. The drying and/or curing temperature should not be too high as it can cause defects such as cracking and warping of the intumescent sheet. The drying and/or curing conditions (e.g. temperature and time duration) depend on many factors such as the thickness of the intumescent sheet to be made, and even the type of oven used, and have to be adjusted accordingly for best results. Optionally, the abovementioned hardening agent can be added to accelerate the drying and/or curing process of the intumescent sheet being produced, which is especially viable for continuous production lines.

According to an example of the present disclosure, there is provided an intumescent sheet. Its composition and associated properties before and after exposure to high temperature are summarized in Tables 1 and 2 respectively. Tables 1 and 2 are provided below. Non-woven glass fiber mat with a thickness of 0.5 mm before impregnation is used. The thickness of the cured intumescent sheet is 0.4 mm. The intumescent sheet can be used as a stand-alone sheet or stacked via layer-by-layer assembly with the same impregnation solution (i.e. alkali-silicate based solution) as described earlier being applied in between the layers. Specifically, the assembly involves stacking layer-by-layer a plurality of the non-woven fiber mats and applying the impregnation solution in between the layers to impregnate each layer of the non-woven fiber mat with the impregnation solution. Cold pressing is applied on a plurality of the stacked layers to form a multi-layer laminate. The stand-alone sheet or multi-layer laminate is to be employed as spacers in an Electric Vehicle (EV) battery, for example, in between cells in an EV battery. They can be made to have the same surface area as the cells or they can be made slightly larger i.e. up to 2-3 cm larger around all sides of a cell. In the event that one cell undergoes thermal runaway, the adjacent intumescent sheet spacer quickly undergoes endothermic degradation and expansion at temperatures as soon as it reaches 200° C. to form a mechanically robust char and good thermal and dielectric insulation. This enables drastic reduction in heat flux and prevention of high-pressured fumes and shrapnel from being transferred over to adjacent cells, thereby preventing them from undergoing thermal runaway. If the area of the intumescent sheet or laminate used is slightly larger than the cells as mentioned above, there is further protection of the adjacent cells from heat attack sideways, i.e. it makes it more difficult for heat to go around the spacer sideways. Depending on the type of cells used, e.g. prismatic cells, when thermal runaway occurs, the participating cell may become dented inwards. Due to the nature of the intumescent sheet, when activated at higher temperatures, it undergoes softening during expansion and upon expansion, solidifies to become a hard char. This enables the char to expand such that it fits the shape of the dent snugly thereby being able to offer enhanced thermal runaway protection to adjacent cells.

TABLE 1
Composition of the Intumescent Sheet

| | Acceptable Loading | Preferred loading |
|---|---|---|
| | Level (wt % of the | level (wt % of the |
| Constituents | Intumescent Sheet) | Intumescent Sheet) |
| Sodium Silicate | 60-95 | 75-85 |
| Surfactant | 0.05-2 | 0.2-1.2 |
| Aerogel | 0.5-10 | 1-5 |
| Metal | 1-10 | 3-8 |
| oxides/hydroxides | | |
| Non-woven glass | 5-20 | 8-16 |
| fiber mat | | |

TABLE 2
Selected Properties of the Intumescent Sheet
Selected Properties of the intumescent sheet

| Property | Value | |
|---|---|---|
| Density of sheet after curing | 1-2 | g/cm³ |
| Expansion Ratio (Char thickness/ | 3-4.5 | |
| original sheet thickness) | | |
| Thermal Conductivity of char after | 0.04-0.15 | W/mK |
| expansion | | |

| | |
|---|---|
| Compressive Strength of char | At 20% strain: 40-300 kPa; |
| | At 40% strain: 250-760 kPa; |
| | At 60% strain: 1000-1400 kPa; and |
| | At 80% strain: 1650-2100 kPa |

Some of the selected properties of the example of the intumescent sheet in Table 2 are obtained in the manner as follows.

The Expansion Ratio is obtained by placing each of a plurality of intumescent sheets onto a hotplate pre-heated to 300° C. for 10 minutes via a “slap-on” procedure to form a fully expanded char. The Expansion Ratio range was determined by calculating the ratio between the thicknesses of the fully expanded char of the intumescent sheets and the original thicknesses of the intumescent sheets before expansion. The original thicknesses of the intumescent sheets tested to determine the Expansion Ratio range were between 0.4-1 mm.

For Thermal Conductivity, intumescent sheets (or laminates) were placed in an enclosed jig with spacers allowing for expansion of the sheets to form char. The enclosed jig ensures that the surface of the char is smooth for accurate testing of thermal conductivity. The set-up of the jig is then placed on a hotplate at 300° C. for 30 minutes. The dimensions of the intumescent sheets were about 20 cm×20 cm. The chars that were obtained were then measured to obtain their thermal conductivity using a heat flow meter (HFM) at room temperature and at 50° C.

As for Compressive Strength, intumescent sheets with dimensions of 5 cm×5 cm were placed on a hotplate at 300° C. for 10 minutes via a “slap-on” procedure to ensure formation of fully expanded char. After the char had cooled down, the char was tested for compressive stress-strain relationship via an Instron mechanical tester with a load cell of 5 kN.

With regard to the “slap-on” procedures mentioned above, specifically, the intumescent sheets are slapped onto the hot plate to ensure that the sheets sit flatly on the hotplate. The purpose is to ensure that the entire area of the intumescent sheet experiences heat evenly and at the same time to produce a char with homogenous expansion.

In an example of the present disclosure, the intumescent sheet or the laminate as described above may be placed in contact with (e.g. sandwiched between) compressible material. The compressible material can be joined together with the intumescent sheet or the laminate via layer-by-layer assembly. They are then used as spacers in between cells in an EV battery. The compressible material includes but are not limited to polymeric foam such as polyurethane foam and silica-aerogel foam. This presents a viable option for meeting of beginning of life (BOL) and end-of-life (EOL) compressibility and thickness-under-compression requirements from EV battery manufacturers.

A thermal runaway (TR) comparison test was done between a polyurethane foam (PUF), which is a widely adopted cell-cell spacer by EV manufacturers and an intumescent sheet-PUF combination of the same thickness. The intumescent sheet that is combined with PUF is similar to that described in the examples above. The TR test was performed on two cell-cell spacers assembled between three prismatic cells of an EV battery with the entire configuration compressed at 100 kPa. For the first spacer, 1.7 mm of PUF was used (1.7 mm is the thickness after compressing the PUF) and for the second spacer, 0.5 mm of the intumescent sheet was assembled with 1.2 mm of polyurethane foam (1.2 mm is the thickness after compressing the PUF). When thermal runaway in the first cell of the three prismatic cells was force-initiated, the PUF in the first spacer melted quickly, resulting in thermal runaway of the adjacent second cell of the three prismatic cells occurring in 73 seconds. However, upon thermal runaway of the second cell, the simultaneous melting of the PUF in the second spacer as well as the expansion of the intumescent sheet to fill the entire spacing (left by the melting of the PUF) provide an excellent thermal insulation barrier that allows for about 16 minutes of thermal protection before the adjacent third cell of the three prismatic cells undergoes thermal runaway. This test demonstrates that the combination of compressible material with the intumescent sheet or the laminate can provide excellent thermal runaway protection in an EV battery.

In one example of the present disclosure, the intumescent sheet or laminate described in the above examples may be employed as inner wall linings of Electric Vehicle (EV) modules and battery pack casings. For inner walls with complicated geometries, a thinner non-woven fiber mat can be used, and/or organic additive can be added in the impregnation solution to improve the flexibility of the intumescent sheet or laminate to be used. A layer-by-layer approach can be adopted, whereby individual intumescent sheet layers (each comprising a non-woven fiber mat) are laid (i.e. laminated) on the inner walls of the EV module and/or battery pack casing. The impregnation solution can be applied between the layers to act as inter-layer adhesive. In this case, there will be multiple layers of non-woven fiber mat, which increase the thermal insulation and mechanical strength of the inner wall. Therefore, the inner wall and its lining will be able to contain the highly pressured fumes and shrapnel coming from multiple cells undergoing thermal runaway. It is preferable that such laminated inner wall linings have a minimum thickness of 1 mm (which is estimated to be about 2 intumescent sheet layers), and preferably at least 2 mm (which is estimated to be about 4 intumescent sheet layers) to give the desired performance.

In another example of the present disclosure, an intumescent tape can be produced from the intumescent sheet or laminate described in the above examples. An adhesive backing is attached onto the intumescent sheet or laminate to form the intumescent tape. This enables ease of layer-by-layer assembly with other materials such as foams to be combined with the intumescent sheet or laminate, or for sticking the intumescent tape as single or multiple layers onto inner walls of a module of an EV battery or an EV battery pack casing.

In summary, examples of the present disclosure relate to thermal runaway management of Electric Vehicle (EV) batteries via the employment of thin inorganic intumescent sheet or sheets or laminate that are used as spacers in between cells. In line with the criticality of space optimization for EV battery manufacturers, the fire-retardant intumescent sheet or sheets or laminate of the examples of the present disclosure are capable of providing the necessary thermal runaway protection at thicknesses of less than or equal to 1 mm.

In another aspect, examples of the present disclosure relate to fire-protection of the Electric Vehicle in the event of multiple cells in the EV battery undergoing thermal runaway. This is done via containment of fire within the respective battery module and/or pack using the intumescent sheet or sheets or laminate of the examples of the present disclosure as inner-wall linings of the battery module and/or pack.

The intumescent sheet or sheets or laminate of the examples of the present disclosure are manufactured via the impregnation of non-woven fiber mat with an alkali-silicate based solution containing a small amount of microporous and/or mesoporous and/or nanoporous additive, which can be aerogel particles, and optionally, a small amount of other char strength-imparting additive such as ceramic powders. Upon curing, the impregnated non-woven fiber mat sheet retains a significant degree of flexibility which is vital in preventing cracks during operation of the EV battery (i.e. due to vibrations/pressures between cells).

During normal operating conditions, the thermal conductivity of the intumescent sheet or sheets or laminate of the examples of the present disclosure are relatively higher, allowing heat-spreading to reduce the risk of any particular cell undergoing thermal runaway. If one of the cells of the EV battery undergoes thermal runaway, the adjacent spacer comprising the intumescent sheet or sheets or laminate can be activated and undergoes expansion as temperatures reach, for example 200° C., in an endothermic fashion. The resultant char can be a mechanically robust inorganic char further supported by the impregnated non-woven fiber, which is able to resist high-pressured fumes and shrapnel. Furthermore, the char has high dielectric resistance and low thermal conductivity due to the presence of the microporous and/or mesoporous and/or nanoporous network, thereby forming an effective barrier to prevent adjacent cells from undergoing thermal runaway.

An example of the intumescent sheet or laminate described in the above examples can be called an FR Blade (or “FR-Blade”). The FR-Blade refers to an intumescent sheet for thermal runaway management of an Electric Vehicle battery. The thickness of the sheet is less than 2 mm, and preferably lesser than or equal to 1 mm. For example, the intumescent sheet is formed by impregnating non-woven inorganic fiber with alkali-silicate based solution (hereinafter “impregnating solution”). The impregnating solution may be a water-based intumescent coating containing aerogel. The impregnating solution may comprise additives and after it is dried and/or cured, the intumescent sheet has an alkali-silicate based coating with the additives.

The composition of the intumescent sheet (after drying) and the composition of the impregnating solution of an example of the FR Blade is described as follows.

The intumescent sheet may comprise a non-woven inorganic fiber mat (or fabric) e.g. ECR-50 from Owen's Corning (a type of E glass). The impregnating solution used for this product comprises a sodium-silicate based binder and aerogel fine particles with hydrophobic surface groups. The particle size of the aerogel particle is between 10-60 μm and its porosity is more than 90%. Alumina (a type of metal oxide) and metal dihydroxide (a type of metal hydroxide) is added as an additive into the impregnating solution to improve the mechanical robustness, insulation and fire-retardant properties of the char produced from the FR Blade under heat exposure.

The tables 3 and 4 below show examples of the composition of the FR Blade after drying and the composition of the impregnating solution.

TABLE 3
Composition of the Intumescent Sheet (After Drying)

| | | Preferred loading |
|---|---|---|
| | | level (weight % of |
| | | the intumescent |
| Constituents | Function | sheet) |
| Dried sodium silicate | Binder | 75-85 |
| Surfactant | Dispersing Agent | 0.2-1.2 |
| Aerogel fine particles with | Main Performance | 1-5 |
| hydrophobic surface groups | Agent (Thermal | |
| | insulation imparting | |
| | additive) | |
| Metal oxides/hydroxides | Sub Performance | 3-8 |
| (e.g. alumina and | Agent (Char strength | |
| magnesium dihydroxide) | enhancing ceramic | |
| | additive) | |
| Non-woven glass fiber mat | Main Performance | 8-16 |
| (e.g. ECR-50 from Owen's | Agent | |
| Corning (a type of E glass) | | |

TABLE 4
Composition of the impregnating solution

| | | Preferred Loading |
|---|---|---|
| | | level (weight % of |
| Constituents | Function | the solution) |
| Sodium silicate (aqueous, | Binder | 92-97 |
| 60 wt % water) | | |
| Surfactant | Dispersing Agent | 0.2-1 |
| Aerogel fine particles with | Main Performance | 0.8-2 |
| hydrophobic surface groups | Agent (Thermal | |
| | insulation imparting | |
| | additive) | |
| Metal oxides/hydroxides (e.g. | Sub Performance | 2.0-4.5 |
| alumina and magnesium | Agent | |
| dihydroxide) | (Char strength | |
| | enhancing ceramic | |
| | additive) | |

In the example, surfactant that is stable in a range of pH 2 to 12 is added to the impregnating solution to improve the ability to spread and wet the non-woven inorganic fiber mat. Preferably, the surfactant is chosen from a group comprising of an amine oxide, an alkyl carbohydrate ester, an alkoxylated polysiloxane and a poly alkyl acrylate. The surfactant loading level is between 0.2 to 0.5 wt % of the impregnating solution, whereas the preferred loading level is 0.2 to 1.2 wt % of the intumescent sheet.

With regard to the non-woven inorganic fiber mat of the present example, besides E-type glass, S-type is another preferred option. If E-type glass is used, E-type glass with boron oxide element removed is most preferred. The diameter and length of the fiber should be between 10-15 μm and 15-60 mm.

Thermal insulation imparting additive (i.e. an agent that enables formation of char with a dense network) that is microporous, such as fumed silica, hollow microglass spheres, can be added. Suitable char strength-imparting ceramic additives can be added, e.g. a combination of metal oxide, metal hydroxide, metal carbonate, metal silicate, and/or metal powder.

In addition to the constituents described above, optionally, the intumescent sheet of the present example can be added with 1 to 10 wt % of an opacifier, such as iron oxide, silicon carbide, and/or titania. The opacifier provides high temperature thermal insulation and serves to reflect and thereby reduce heat transfer via radiation at high temperatures.

The organic additive can be added at the impregnation station (where the impregnation of the non-woven inorganic fiber mat and the impregnating solution is performed) to enhance flexibility and water resistance of the intumescent sheet. Glycerol and polyvinyl alcohol are preferred examples of organic additives.

The production of the impregnating solution involves the sequential addition of alkali-silicate solution and one or more surfactant(s), followed by insulation imparting agents, char strength-imparting agents and other additives, and finally the necessary amount of water with stir-mixing after each step (i.e. after adding each component sequentially) for of less than 30 minutes (e.g. 15 minutes) and finally stir-mixing solution with all added components for a further 2-3 hours. Hardening agent is the last constituent to be added into the impregnating solution and it is just before impregnating the non-woven inorganic fiber mat. The viscosity is preferably between 200-500 centipoise (cps).

The hardening agent is preferably sodium fluorosilicate or Potassium methyl siliconate (being the most preferred).

If opacifier, hardening agent, and water are added, the composition of the impregnating solution is in table 5 as follows.

TABLE 5
Composition of the impregnating solution (Variation
of the product in table 3 above)

| | Loading level |
|---|---|
| | (wt % of the |
| Constituents | solution) |
| Sodium silicate (aqueous, 60 wt % water) | 70-95 |
| Surfactant | 0.05-2 |
| Aerogel fine particles with hydrophobic | 0.5-10 |
| surface groups | |
| Metal oxides/hydroxides (e.g. alumina and | 1-10 |
| magnesium dihydroxide) | |
| Opacifier | 1-10 |
| Organic additive (e.g. glycerol) | Less than 10 |
| Hardening agent (e.g. potassium methyl | Less than 10 |
| siliconate) | |
| Water | 2-10 |

Multiple sheets of the intumescent sheet may be stacked to form a laminate together by applying the impregnating solution in between the layers and cold pressing the plurality of intumescent sheets.

In one use scenario of a product in an Electric Vehicle (EV) battery, the intumescent sheet or laminate described above is placed in contact with a polymeric foam that is a compressible material, such as polyurethane form (PUF), which is used as a cell spacer. The area of the intumescent sheet/laminate is preferably larger than the cell's surface area, to cover all sides of the cell by 2-3 cm to provide further protection of adjacent from heat attack sideways.

Upon thermal runaway of one cell in the EV battery, the simultaneous melting of the PUF in the spacer as well as the expansion of the intumescent sheet to fill the entire spacing (left by the melting of the PUF) provides a thermal insulation barrier to prevent the occurrence of thermal runaway in an adjacent cell of a module of the battery.

In another use scenario of the product in the EV battery, an adhesive backing is attached onto the intumescent sheet or laminate as described above to form an intumescent tape. This enables ease of layer-by-layer assembly with other materials, such as aerogel foams, mica sheet, etc. i.e. the intumescent sheet or laminate in the form of tape can be adhered to these other materials that are to be placed in the EV battery for thermal runaway management. Furthermore, the intumescent tape can be taped as single or multiple layers onto inner walls of a module of an EV battery or an EV battery pack casing.

To produce the intumescent sheet, the non-woven inorganic fibermat is firstly layered on a non-stick polymeric sheet and impregnated by an aqueous alkali-silicate based solution (i.e. the impregnating solution).

Various methods of impregnation could be adopted such as spraying, brushing and/or doctor-blading. Preferably, doctor-blading is adopted for better thickness control and viability for high volume production. Drying is then performed at a suitable temperature (e.g. room temperature) to remove the water without causing defects such as warping. Optionally, curing can be performed at a higher temperature (e.g. via microwave heating) to quicken the process.

Other char strength enhancing additives that may be added include Zirconium Oxide and Colloidal silica. Sodium Silicate is defined by the molar ratio between Silica:sodium oxide. Increasing the ratio of silica enables the formation of a stronger char and the addition of Colloidal silica can adjust the increase.

Another example of the FR-Blade described above may have the following properties:

### Intumescent Properties:

Reacts rapidly at temperatures >175° C.
Expands to 5 times original thickness
Creates an insulating foam that fills voids and reduces heat transfer
Non-combustible, inorganic formulation

The FR-Blade may be a flexible sheet material, manufactured in bulk rolls for lamination and die-cutting. The FR-Blade may be available in standard thickness of 0.4 mm-1.0 mm. See Table 6 below for details (i.e. 6(A) and 6(B)).

TABLE 6
Typical Properties of the FR-Blade
6(A) Typical Properties - 0.4 mm thickness

| Property | Value |
|---|---|
| Weight per unit area | 650 g/sqm +/− 10% (0.133 lb/sq. ft) |
| Expansion activation | 150-200 degrees Celsius |
| temperature | (302-392 degrees Fahrenheit) |
| Tensile Strength | >300N (MD), >150N (TD), ISO 1924-2 |
| Expansion Ratio | 4-5 times initial thickness at 600 |
| | degrees Celsius |
| Compressive Strength | 17% strain at 500 kPa |
| Thermal Conductivity* | <0.06 +/− 0.01 W/(m-K) at 24 degrees |
| | Celsius) |

6(B) Product Range

| Property | | |
|---|---|---|
| Colour | White | |
| Thickness, mm (in) | 0.40-1.00 (0.016-0.04) | ISO 534: 2011 |
| REACH | Compliant | REACH candidate list of |
| | | SVHC 10.06.2022 |
| RoHS | Compliant | RoHS Directive (EU) |
| | | 2015/863 |

*at five-times expansion

In one example, the FR-Blade may be a sheet that is squarish or rectangular in shape, which is a shape suitable for most EV batteries.

The FR-Blade may be used alone or inserted as a layer with other layer or layers of materials (e.g. PUF, other thermal insulation material, etc.).

The FR-Blade may be supplied from a bulk roll. A die-cutting process may be used to cut the FR-Blade into the correct size.

The FR-Blade may be supplied from more than one FR-Blades that are stacked to one another. In this case, a release liner may be provided between the layers of the more than one FR-Blades.

Examples of the present disclosure may have the following features.

An intumescent sheet to be used in an Electric Vehicle Battery for thermal runaway management, wherein out of 100 weight percentage (wt %) of the intumescent sheet, the intumescent sheet comprises:
5 to 20 wt % of non-woven fiber mat;
60 to 95 wt % of an alkali-silicate based binder; and
0.5 to 10 wt % of microporous and/or mesoporous and/or nanoporous additive,
wherein the non-woven fiber mat is infused with the alkali-silicate based binder by impregnation of the non-woven fiber mat with an alkali-silicate based solution.

The intumescent sheet may have a thickness of lesser than or equal to 1 mm.

The alkali-silicate based binder may have a silicon dioxide:alkali oxide molar ratio in the range of 2.5 to 4.

The alkali-silicate based binder may have a silicon dioxide:alkali oxide molar ratio in the range of 3 to 3.3.

The intumescent sheet may comprise 75 to 85 wt % of the alkali-silicate based binder.

The microporous and/or mesoporous and/or nanoporous additive may comprise aerogel particles with hydrophobic surface groups.

The aerogel particles may have particle sizes of 10-60 μm, pore diameters of 5 to 50 nm, porosity of greater than 90%, bulk density of 0.02 to 0.1 g/cm³ and surface area of 500 to 900 m²/g.

The microporous and/or mesoporous and/or nanoporous additive may comprise hollow microglass spheres, fumed silica, and/or cenospheres.

The intumescent sheet may comprise 1 to 10 wt % of an opacifier comprising any one or combination of iron oxide, silicon carbide, and titania.

The intumescent sheet may comprise of 1 to 10 wt % of char strength-imparting ceramic additive comprising any one or combination of metal oxide, metal hydroxide, metal carbonate, metal silicate and metal powder.

The intumescent sheet may comprise 3 to 8 wt % of the char strength-imparting ceramic additive.

The char strength-imparting ceramic additive may comprise magnesium oxide, aluminium oxide, calcium oxide, and/or zinc oxide.

The char strength-imparting ceramic additive may comprise aluminium trihydrate and/or magnesium dihydroxide.

The char strength-imparting ceramic additive may comprise calcium carbonate and/or zinc carbonate.

The char strength-imparting ceramic additive may comprise mica and/or talc.

The char strength-imparting ceramic additive may comprise the metal powder, and the metal powder comprises iron, zinc and/or aluminium.

The alkali-silicate based solution may comprise, out of 100 wt % of the alkali-silicate based solution, 0.05 to 2 wt % of a surfactant that is stable in the range of pH 2 to 12.

The alkali-silicate based solution may comprise 0.2 to 0.5 wt % of the surfactant.

The intumescent sheet may comprise less than 10 wt % of a hardening agent, which comprises sodium fluorosilicate and/or potassium dimethyl siliconate.

The intumescent sheet may comprise less than 10 wt % of an organic additive, which comprises polyvinyl alcohol and/or glycerol.

The non-woven fiber mat may comprise glass fibers of E and/or S type.

The non-woven fiber mat may comprise fibers with diameter and length of between 8 to 18 μm and 10 to 75 mm respectively.

The non-woven fiber mat may comprise fibers with diameter and length of between 10 to 15 μm and 15 to 60 mm respectively.

The non-woven fiber mat may comprise, out of 100 wt % of the non-woven fiber mat, 5 to 20 wt % of acrylic resin as a binder.

The non-woven fiber mat may comprise 8 to 15 wt % of the acrylic resin.

The non-woven fiber mat may have an area density below 400 g/m².

The non-woven fiber mat may have an area density of between 30 to 280 g/m².

The intumescent sheet may comprise 8 to 16 wt % of the non-woven fiber mat.

The intumescent sheet may be made 2 to 3 cm larger around all sides of a cell of the EV battery.

The intumescent sheet may comprise:
8 to 16 wt % of non-woven fiber mat;
75 to 85 wt % of an alkali-silicate based binder;
1 to 5 wt % of aerogel fine particles with hydrophobic surface groups; and
3 to 8 wt % of metal oxide and/or hydroxide.

Out of 100 weight percentage (wt %) of the alkali-silicate based solution, the alkali-silicate based solution may comprise:
92 to 97 wt % of an alkali-silicate and water;
0.2 to 1 wt % of a surfactant;
0.8 to 2 wt % of aerogel fine particles with hydrophobic surface groups; and
2 to 4.5 wt % of metal oxide and/or hydroxide.

Out of 100 weight percentage (wt %) of the alkali-silicate based solution, the alkali-silicate based solution may comprise:
70 to 95 wt % of alkali-silicate and water;
0.05 to 2 wt % of a surfactant;
0.5 to 10 wt % of aerogel fine particles with hydrophobic surface groups;
1 to 10 wt % of metal oxide and/or hydroxide;
1 to 10 wt % of Opacifier;
less than 10 wt % of an organic additive;
less than 10 wt % of a hardening agent;
2 to 10 wt % of water in addition to the 70 to 95 wt % of alkali-silicate and water.

A method of manufacturing the intumescent sheet, wherein the method comprises:
impregnating the non-woven fiber mat with the alkali-silicate based solution by coating the non-woven fiber mat with the alkali-silicate based solution using doctor-blading technique; and
drying the impregnated non-woven fiber mat.

The method may comprise:
making the alkali-silicate based solution by:
   a) addition of alkali-silicate in the form of a solution;
   b) addition of one or more surfactants to the solution of step a) to form a mixture;
   c) addition of thermal insulation imparting agents to the mixture;
   d) addition of char strength-imparting agents to the mixture;
   e) addition of water to the mixture;
   f) addition of a hardening agent to the mixture;
   g) stir-mixing the mixture after each of steps a) to f) for a predetermined time duration of less than 30 minutes; and
   h) stir-mixing for about 2 to 3 hours after all components have been added to the mixture.

A laminate including a plurality of stacked layers, wherein each layer is the intumescent sheet.

A method for manufacturing the laminate, wherein the method comprises:
stacking layer-by-layer a plurality of the non-woven fiber mat and applying the alkali-silicate based solution in between the layers to impregnate each layer of the non-woven fiber mat with the alkali-silicate based solution; and
cold pressing the plurality of stacked layers to form the laminate.

The intumescent sheet and/or the laminate may comprise an adhesive backing to facilitate taping of the intumescent sheet and/or the laminate on a surface.

An Electric Vehicle (EV) Battery comprising one or more spacers located between cells in the EV battery to prevent thermal runaway in adjacent cells when one cell is undergoing thermal runaway, wherein the one or more spacers comprise the intumescent sheet and/or the laminate.

The one or more spacers may comprise a compressible material in contact with the intumescent sheet and/or the laminate.

The intumescent sheet and/or the laminate may be linings in inner walls of a module formed by a plurality of the cells and/or linings in inner walls of a battery pack casing of the EV battery.

In the specification and claims, unless the context clearly indicates otherwise, the term “comprising” has the non-exclusive meaning of the word, in the sense of “including at least” rather than the exclusive meaning in the sense of “consisting only of”. The same applies with corresponding grammatical changes to other forms of the word such as “comprise”, “comprises” and so on.

While the invention has been described in the present disclosure in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. An intumescent sheet to be used in an Electric Vehicle (EV) Battery for thermal runaway management, wherein the intumescent sheet comprises:
a non-woven fiber mat;
60 to 95 wt % of an alkali-silicate based binder; and
microporous and/or mesoporous and/or nanoporous additive,
wherein the non-woven fiber mat is infused with the alkali-silicate based binder by impregnation of the non-woven fiber mat with an alkali-silicate based solution.

2. The intumescent sheet of claim 1, wherein the intumescent sheet has a thickness of lesser than or equal to 1 mm.

3. The intumescent sheet of claim 1, wherein the alkali-silicate based binder has a silicon dioxide:alkali oxide molar ratio in the range of 2.5 to 4.

4. The intumescent sheet of claim 1, wherein the alkali-silicate based binder has a silicon dioxide:alkali oxide molar ratio in the range of 3 to 3.3.

5. The intumescent sheet of claim 1, wherein the intumescent sheet comprises 75 to 85 wt % of the alkali-silicate based binder.

6. The intumescent sheet of claim 1, wherein the microporous and/or mesoporous and/or nanoporous additive comprises aerogel particles with hydrophobic surface groups.

7. The intumescent sheet of claim 6, wherein the aerogel particles have particle sizes of 10-60 μm, pore diameters of 20 to 100 nm, porosity of greater than 90%, bulk density of 0.02 to 0.1 g/cm³ and surface area of 500 to 900 m²/g.

8. The intumescent sheet of claim 1, wherein the microporous and/or mesoporous and/or nanoporous additive comprises hollow microglass spheres, fumed silica, and/or cenospheres.

9. The intumescent sheet of claim 1, wherein the intumescent sheet comprises 1 to 10 wt % of an opacifier comprising any one or combination of iron oxide, silicon carbide, and titania.

10. The intumescent sheet of claim 1, wherein the intumescent sheet comprises char strength-imparting ceramic additive comprising any one or combination of metal oxide, metal hydroxide, metal carbonate, metal silicate and metal powder.

11. The intumescent sheet of claim 10, wherein the intumescent sheet comprises 3 to 8 wt % of the char strength-imparting ceramic additive.

12. The intumescent sheet of claim 10, wherein the char strength-imparting ceramic additive comprises any one or combination of magnesium oxide, aluminium oxide, calcium oxide, and zinc oxide.

13. The intumescent sheet of claim 10, wherein the char strength-imparting ceramic additive comprises aluminium trihydrate and/or magnesium dihydroxide.

14. The intumescent sheet of claim 10, wherein the char strength-imparting ceramic additive comprises calcium carbonate and/or zinc carbonate.

15. The intumescent sheet of claim 10, wherein the char strength-imparting ceramic additive comprises mica and/or talc.

16. The intumescent sheet of claim 10, wherein the char strength-imparting ceramic additive comprises the metal powder, and the metal powder comprises iron, zinc and/or aluminium.

17. The intumescent sheet of claim 1, wherein the alkali-silicate based solution comprises a surfactant that is stable in the range of pH 2 to 12.

18. The intumescent sheet of claim 17, wherein the alkali-silicate based solution comprises 0.2 to 0.5 wt % of the surfactant.

19. The intumescent sheet of claim 1, wherein the intumescent sheet comprises a hardening agent, which comprises sodium fluorosilicate and/or potassium dimethyl siliconate.

20. The intumescent sheet of claim 1, wherein the intumescent sheet comprises an organic additive, which comprises polyvinyl alcohol and/or glycerol.

21. The intumescent sheet of claim 1, wherein the non-woven fiber mat comprises glass fibers of E and/or S type.

22. The intumescent sheet of claim 1, wherein the non-woven fiber mat comprises fibers with diameter and length of between 8 to 18 μm and 10 to 75 mm respectively

23. The intumescent sheet of claim 22, wherein the non-woven fiber mat comprises fibers with diameter and length of between 10 to 15 μm and 15 to 60 mm respectively.

24. The intumescent sheet of claim 1, wherein the non-woven fiber mat comprises 5 to 20 wt % of acrylic resin as a binder.

25. The intumescent sheet of claim 24, wherein the non-woven fiber mat comprises 8 to 15 wt % of the acrylic resin.

26. The intumescent sheet of claim 1, wherein the non-woven fiber mat has an area density below 400 g/m².

27. The intumescent sheet of claim 1, wherein the non-woven fiber mat has an area density of between 30 to 280 g/m².

28. The intumescent sheet of claim 1, wherein the intumescent sheet comprises 8 to 16 wt % of the non-woven fiber mat.

29. The intumescent sheet of claim 1, wherein the intumescent sheet is made 2 to 3 cm larger around all sides of a cell of the EV battery.

30. The intumescent sheet of claim 1, wherein the intumescent sheet comprises:
8 to 16 wt % of non-woven fiber mat;
75 to 85 wt % of an alkali-silicate based binder;
1 to 5 wt % of aerogel fine particles with hydrophobic surface groups; and
3 to 8 wt % of metal oxide and/or hydroxide.

31. The intumescent sheet of claim 1, wherein the alkali-silicate based solution comprises:
92 to 97 wt % of an alkali-silicate and water;
a surfactant;
aerogel fine particles with hydrophobic surface groups; and
a metal oxide and/or hydroxide.

32. The intumescent sheet of claim 1, wherein the alkali-silicate based solution further comprises:
an opacifier;
an organic additive; and
a hardening agent.

33. A method of manufacturing the intumescent sheet of claim 1, wherein the method comprises:
impregnating the non-woven fiber mat with the alkali-silicate based solution by coating the non-woven fiber mat with the alkali-silicate based solution using doctor-blading technique; and
drying the impregnated non-woven fiber mat.

34. The method of claim 33, wherein the method comprises:
making the alkali-silicate based solution by:
a) addition of alkali-silicate in the form of a solution;
b) addition of one or more surfactants to the solution of step a) to form a mixture;
c) addition of thermal insulation imparting agents to the mixture;
d) addition of char strength-imparting agents to the mixture;
e) addition of water to the mixture;
f) addition of a hardening agent to the mixture;
g) stir-mixing the mixture after each of steps a) to f) for a predetermined time duration of less than 30 minutes; and
h) stir-mixing for 2 to 3 hours after all components have been added to the mixture.

35. A laminate including a plurality of stacked layers, wherein each layer is the intumescent sheet of claim 1.

36. A method for manufacturing the laminate of claim 35, wherein the method comprises:
stacking layer-by-layer a plurality of the non-woven fiber mat and applying the alkali-silicate based solution in between the layers to impregnate each layer of the non-woven fiber mat with the alkali-silicate based solution; and
cold pressing the plurality of stacked layers to form the laminate.

37. The intumescent sheet of claim 1, wherein the intumescent sheet comprises an adhesive backing to facilitate taping of the intumescent sheet on a surface.

38. An Electric Vehicle (EV) Battery comprising one or more spacers located between cells in the EV battery to prevent thermal runaway in adjacent cells when one cell is undergoing thermal runaway, wherein the one or more spacers comprise the intumescent sheet of claim 1 and/or a laminate including a plurality of stacked layers, wherein each layer is the intumescent sheet.

39. The EV Battery of claim 38, wherein the one or more spacers comprise a compressible material in contact with the intumescent sheet and/or the laminate.

40. The EV battery of claim 38, wherein the intumescent sheet and/or the laminate are linings in inner walls of a module formed by a plurality of the cells and/or linings in inner walls of a battery pack casing of the EV battery.
